(19) United States
(12) Patent Application Publication
(10) Pub. No.: US 2011/0212288 A1
(43) Pub. Date: Sep. 1, 2011

(54) FOAM/ADHESIVE COMPOSITE AND METHODS OF USE THEREOF

(75) Inventors: Stephen R. McClure, San Francisco, CA (US); Carl Peterson, Santa Clara, CA (US); Kevin Gibbs, Menlo Park, CA (US)

(73) Assignee: APPLE INC., Cupertino, CA (US)

(21) Appl. No.: 12/793,910

(22) Filed: Jun. 4, 2010

Related U.S. Application Data
(60) Provisional application No. 61/309,410, filed on Mar. 1, 2010.

(51) Int. Cl. B44C 1/28; B05D 5/10; B44C 1/26; B32B 3/06; C09J 7/02

(52) U.S. Cl. 428/67; 428/305.5; 427/207.1; 428/117

(57) ABSTRACT

A composite formed by impregnating open cell foam having a plurality of foam cells with liquid adhesive, wherein the liquid adhesive fills most of the plurality of foam cells, wherein in an uncured state, the composite remains pliable and compressible, wherein in a cured state, the composite becomes rigid and is capable of adhering to a surface in contact therewith, and wherein in the uncured state, the composition responds to applied pressure to a surface of the composite by generating a counter pressure uniformly along the surface.

### CROSS REFERENCE TO RELATED APPLICATIONS

This patent application takes priority under 35 U.S.C. 119(e) of U.S. Provisional Patent Application having Ser. No. 61/309,410 entitled “FOAM/ADHESIVE COMPOSITE AND METHODS OF USE THEREOF” by McClure et al. filed Mar. 1, 2010 which is incorporated by reference in its entirety for all purposes.

### BACKGROUND

1. Field of the Invention

The invention relates to consumer products, and more particularly, methods and apparatus for controlling the fit of cosmetic parts attached to a consumer electronic product.

2. Description of the Related Art

Consumer products occasionally require the attachment of parts that while not essential to the operation of the consumer electronic product, still must conform to the overall aesthetic look and feel of the product as a whole. It would be of little benefit for a manufacturer to expend a large amount of resources in both time and money in developing an aesthetically pleasing consumer product that with the addition of a minor cosmetic part degrades the overall look and feel of the product. Most consumers would tend to focus on any small imperfection that could result in an overall degradation in their appreciation of the product.

For example, the overall fit and finish of the product can be as almost an important factor to a consumer's appreciation of a product as the functionality of the product itself. Therefore, it is essential that any cosmetic part attached to a consumer product, especially to that portion of the consumer product that is readily visible, be attached in such a way as to appear that the cosmetic part is part of the whole and not added on.

Therefore, an improved manner of attaching a cosmetic part to a consumer product is desired that is strong, easily practiced, and results in a fit and finish that enhances the overall look and feel of the product.

### SUMMARY

Broadly speaking, the embodiments disclosed herein describe a composite formed of an open cell foam material impregnated with an adhesive.

A composite material includes at least a foam substrate interspersed with a plurality of foam cells having an average foam cell size related to a porosity of the foam substrate and a liquid adhesive having a viscosity value. In the described embodiment, the viscosity value of the liquid adhesive and the foam substrate porosity are interrelated in such a way that an amount of the liquid adhesive migrates into the foam substrate such that most of the plurality of foam cells within at least a first portion of the foam substrate are substantially and uniformly filled with the liquid adhesive.

A small form factor consumer product is described that includes at least a housing arranged to enclose a plurality of operational components, the housing having a form factor small enough to be easily carried about by a user with one hand, a feature attached to the housing at a reveal, and an adhesive composite arranged to adhesively attach together the feature such that the reveal is not visible to the user and is not tangible to the user. In the described embodiment, the adhesive composite is formed of at least a foam substrate having a number of foam cells, and substantially uniform distribution of liquid adhesive amongst the number of foam cells.

A method can be carried out by performing at least the following operations: providing a foam substrate having a range of porosity values, determining a viscosity of a first liquid adhesive, the viscosity of the liquid adhesive in accordance with a substantially uniform distribution of the liquid adhesive in at least a portion of the foam substrate, and forming a foam/adhesive composite material by causing the liquid adhesive to impregnate at least the portion of the foam substrate.

Other aspects and advantages will become apparent from the following detailed description taken in conjunction with the accompanying drawings which illustrate, by way of example, the principles of the invention.

### BRIEF DESCRIPTION OF THE DRAWINGS

The described embodiments will be readily understood by the following detailed description in conjunction with the accompanying drawings, wherein like reference numerals designate like structural elements, and in which:

FIG. 1 shows a representative cross section of composite formed of open cell foam substrate having a plurality of cells most of which are filled, or at least substantially filled, with adhesive.

FIG. 2 shows a cross section of housing onto which the composite is used to attach a representative feature.

FIGS. 3-4 show a particular approach that can be used to attach a feature, such as an antenna window to a housing the composite.

FIG. 5 shows a cross sectional view of an embodiment of a composite having a pre-determined non-uniform distribution of adhesive throughout foam substrate.

FIG. 6A-6B shows an embodiment of a composite used to form a mechanism such as an actuator.

FIG. 7 shows a hinge configuration.

FIGS. 8A, 8B, and 8C show a composite in the form of molded composite having a rectilinear shape (FIG. 8A) a curvilinear shape (FIG. 8B), and general shape (FIG. 8C).

FIG. 9 shows a self fixturing embodiment.

FIG. 10 shows a shock mount embodiment.

FIG. 11 shows a flowchart detailing a process in accordance with the embodiments.

### DETAILED DESCRIPTION OF THE DESCRIBED EMBODIMENTS

In the following detailed description, numerous specific details are set forth to provide a thorough understanding of the concepts underlying the described embodiments. It will be apparent, however, to one skilled in the art that the described embodiments can be practiced without some or all of these specific details. In other instances, well known process steps have not been described in detail in order to avoid unnecessarily obscuring the underlying concepts.

Broadly speaking, the embodiments herein describe a composite that includes at least a foam substrate formed of a plurality of foam cells. In one embodiment at least one liquid adhesive can be uniformly distributed throughout the plurality of foam cells. In order to maximize the likelihood that the liquid adhesive is uniformly distributed in the foam substrate, the viscosity (μ) of the liquid adhesive and the average foam cell size (referred to as porosity measured in pores per inch, or PPI) are considered. As well known in the art, viscosity is a measure of liquid's resistance to flow, i.e., the lower/higher the viscosity the lesser/greater the resistance to flow. For example, water has a lower resistance to flow than molasses and as a consequence, water has a lower value of viscosity (μ≈1.0 cP) than molasses (μ≈5000 cP). The known viscosity of the liquid adhesive to be used to form the composite can determine in part the choice of a foam substrate based upon a range of porosity likely to result in a substantially uniform distribution of the liquid adhesive. Alternatively, if the porosity of the foam substrate is known, then a liquid adhesive of the proper viscosity can be selected. For example, in order to assure that a foam substrate having a porosity in the range of between 100 and 200 PPI is fully impregnated with liquid adhesive, the viscosity of the liquid adhesive can be on the order of that approximating water, namely about 1 cP. However as the porosity decreases (i.e., the average foam cell size increases) to about 15 ppi, the viscosity of the liquid adhesive will commensurably increase.

That having been said, once the foam substrate and liquid adhesive have been selected, the liquid adhesive can be introduced to the foam substrate in any number of ways. For example, in one particularly simple approach, the foam substrate can be immersed into a bath of liquid adhesive thereby allowing the liquid adhesive to migrate through the foam substrate by filling the voids represented by the plurality of foam cells. In some cases, it may be advantageous to modify the external conditions in order to facilitate the migration of the liquid adhesive through the foam substrate. For example, the liquid adhesive can be put under pressure providing an additional impetus for the liquid adhesive to migrate through the foam substrate. Other approaches can include exposing the foam substrate to a vacuum or other negative pressure and then introducing the liquid adhesive to be forcibly drawn into the foam substrate by way of the pressure differential.

In some cases, the foam substrate can be impregnated with more than one species of adhesive uniformly distributed throughout the foam substrate. In this way the different species of adhesive can cooperate to provide the composite with compound properties that can work in synergy with each other. For example, a first thermal cure adhesive having a first cure temperature can be combined with a second thermal cure adhesive having a second cure temperature that is higher than the first cure temperature. In this way, the first adhesive can cure without substantially any cure of the second adhesive providing, for example, a technique for self fixturing of an assembly cured at or above the second cure temperature.

In any case, once the composite is properly constituted, the liquid adhesive is for the most part uniformly distributed throughout the foam substrate and can be used to control a fit between cosmetic parts attached to a housing of, for example, a small form factor consumer electronic product. In one approach, when the composite is in an uncured state (i.e., the liquid adhesive has not “set”), the composite can be placed in contact with at least one surface of at least one of the parts slated to be joined together to form what is referred to as an assembly. Even in the uncured state, the composite can possess sufficient inherent “stickiness” that no additional effort is required for the composite to remain attached to the surface thereby allowing an easy assembly process.

The assembly can then be subjected to an external “fixturing” force that compels the assembly to conform to the desired specifications of the finished product. Due to the natural tendency of the foam substrate to return to its original dimensions, the composite responds to the compressive fixturing force by generating a uniform preload force in an opposite direction (and normal to composite surface) to that of the fixturing force having a magnitude in line with a spring force of the foam substrate alone. In this way, the uniform pre-load force can be used to better control the alignment and placement of the constituent parts of the assembly thereby assuring close fit between the constituent parts of the assembly. It should be noted that in order to optimize the advantages presented by the uniform pre-load force, consideration is taken of the natural spring force of the substrate and post cure properties of the liquid adhesive, such as, for example, post cure expansion or contraction and so on. While still fixtured within the fixturing device, the adhesive portion of the composite is cured. For thermal cure type adhesives, fixture heating to at least a cure temperature for at least a cure time. For example, the fixturing device can be heated by using an external heat source that can raise the temperature of at least the assembly to at least the curing temperature and held there for at least the cure time. In this way, the cured adhesive is incorporated into the lattice of foam cells.

In some cases, the adhesive can take the form of a binary type adhesive, such as a two part epoxy formed of a base agent and a linking agent. At least a portion of the composite can be impregnated with the base agent by incorporating the base agent into that part of the foam substrate nearest a surface of the composite to be placed against the part(s) to be attached. The linking agent can be placed on those surfaces of the parts to be attached that are to be placed in direct contact with corresponding surfaces of the composite having the base agent. In this way, a binary reaction (i.e., cross linking) can occur between the base agent and the linking agent when the composite is brought in contact with the parts to be attached and compressed by the fixturing device. In another embodiment, the adhesive can be a UV cure type adhesive allowing the composite to be formed into any shape deemed appropriate. For example, the composite can take on a curvilinear shape and compressed in such a way that the counterforce generated by the foam in the compressed state is in a direction normal to a surface of the compressed curvilinear shaped composite.

In additional embodiments, a composite having regions of differing properties can be formed by providing a predetermined and well defined non-uniform distribution of a liquid adhesive in the foam substrate. This non-uniform distribution of liquid adhesive can take many forms not the least of which is the non-uniform distribution of a single species of liquid adhesive, the non-uniform distribution of two different specifies of liquid adhesive (such as one species having a lower cure temperature than a second species, one species having a different curing process vis a vis the other species, and so on). The pre-determined non-uniform distribution of the liquid adhesive can result in the composite having overall composite properties not possible with the composite having the uniform distribution. For example, a composite can have regions of differing mechanical properties based upon the characteristics of the liquid adhesives used to impregnate those regions. For example, a first region of the substrate can be impregnated with a first species of liquid adhesive characterized as having a first cure temperature that is lower than of a second species of liquid adhesive used to impregnate a second region. In this configuration, when the composite is exposed to a temperature greater than the first cure temperature and less than the second cure temperature, the first region will have substantially different properties than that of the uncured second region.

One of the many advantages to the composite is that there is essentially no post cure shrinkage of the composite as compared to the post cure shrinkage evident when adhesive alone is used. Therefore, the composite can provide a well controlled and easy to use approach to bonding parts together in a cosmetically appealing manner. The composite is also well suited for attaching features to small form factor electronic devices. The features can include for example, an antenna window attached to a housing of the small form factor electronic device.

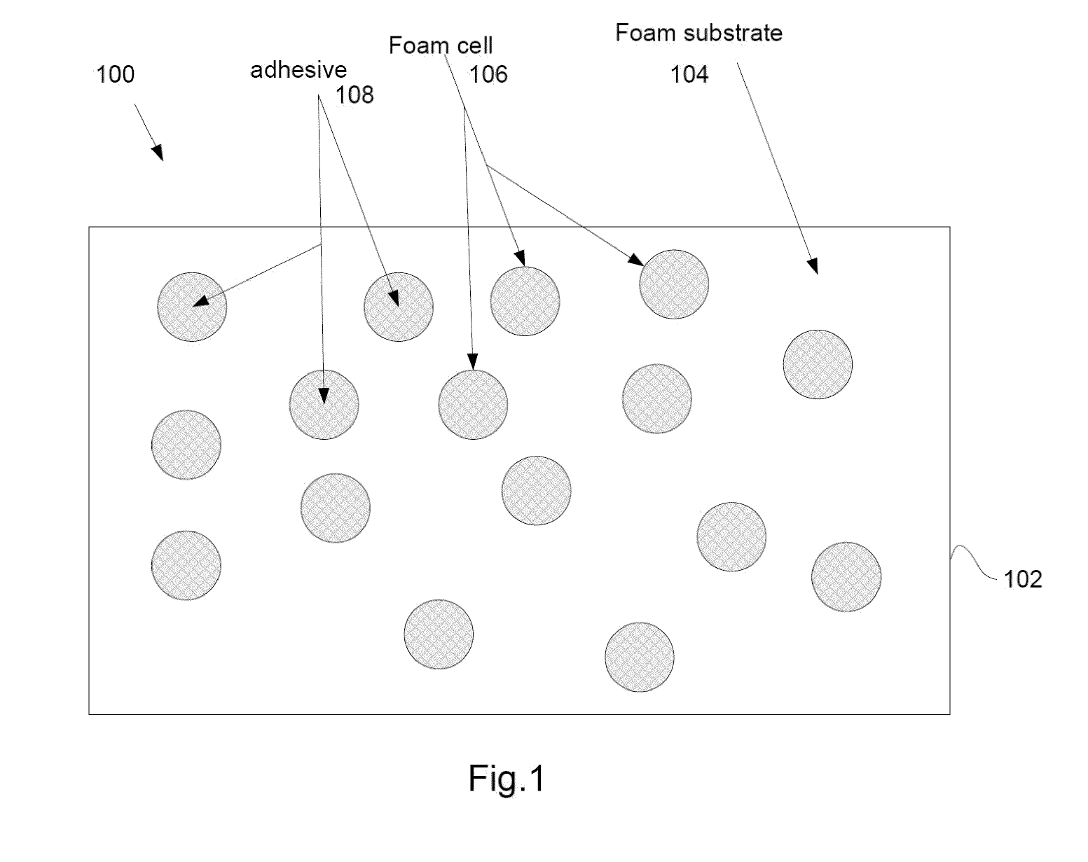

These and other embodiments are discussed below with reference to FIGS. 1-11. However, those skilled in the art will readily appreciate that the detailed description given herein with respect to these figures is for explanatory purposes only and should not be construed as limiting.

FIG. 1 shows a representative cross section 100 of composite 102 formed of open cell foam substrate 104 having foam cells 106 most of which are filled, or at least substantially filled, with liquid adhesive 108. In order to provide a uniform and strong bond, the distribution of liquid adhesive throughout foam substrate 104 is made essentially uniform by impregnating a substantial portion of foam substrate 104 with single species adhesive 108. Composite 102 is well suited for bonding together pieces of small form factor consumer products that require both a strong bond and an esthetically and cosmetically pleasing reveal. This particularly important in those products that place a high premium on presenting a clean look and uniformly smooth feel to the user such as in small form factor consumer products where even a small imperfection can substantially detract from a user's overall experience. For example, if a small form factor consumer product has a housing onto which another part is attached, any flaws or other imperfections caused by the attachment process can be easily noticed drawing the attention of even casual observers. The adhesive nature of composite 102 can be used to bond a number of parts together to form an aesthetically pleasing assembly exhibiting essentially no reveals, lines or other joining related visual or tactile artifacts. In this way, an accessory or other structural feature can be joined to a housing of a small form factor consumer product using composite 102 without leaving tell tale evidence of the joining, either visual or tactile.

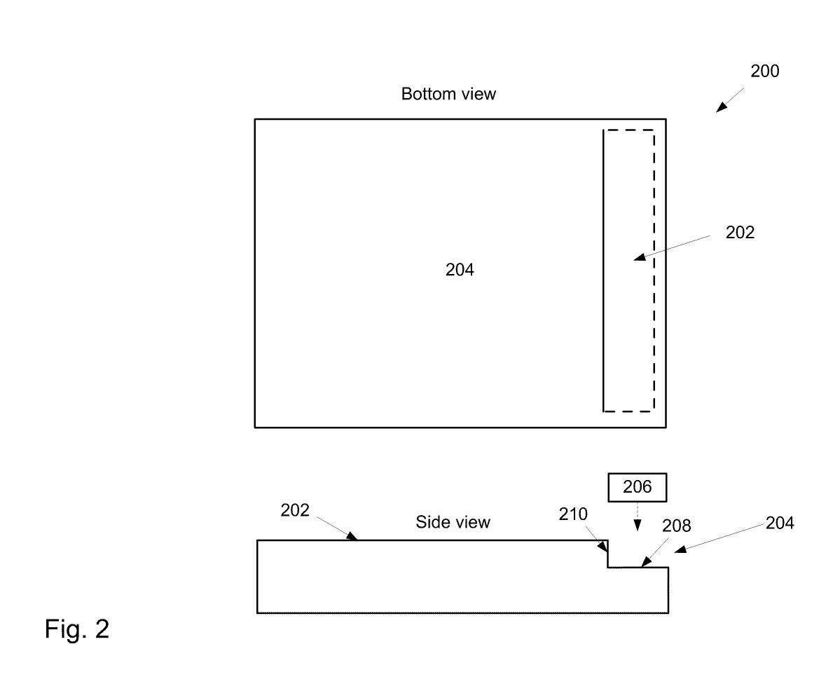

FIG. 2 shows a cross section of housing 200 onto which composite 102 is used to attach a representative feature. Housing 200 that can be formed of any number of materials such as plastic or metal which can be forged, molded, or otherwise processed into a desired shape. In any case, housing 200 can enclose and support internally various structural and electrical components (including integrated circuit chips and other circuitry) to provide computing operations for a portable computing device. For example, housing 200 can be used to enclose and support operational components of a portable communication device such as an iPhone™ or iPad™ each manufactured by Apple Inc. of Cupertino, Calif. Housing 200 can be configured to accommodate features having ornamental and/or functional aspects.

When housing 200 is formed of metal and is used to enclose at least some operational components that the portable communication device (such as an RF antenna) that support RF based functionality, it is advantageous to remove a portion of housing 200 to form recess 202. Recess 202 can include part of bottom surface 204 of housing 200. Recess 202 can be sized to accommodate a feature formed of RF transparent materials such as ceramic, or plastic. Accordingly, recess 202 can be formed in close proximity to an RF antenna enclosed within housing 200 used to send and receive RF energy. Therefore, in order to minimize RF signal degradation caused by the presence of metal housing 200, recess 202 can be replaced with feature 206, formed of radio transparent material, commonly referred to as antenna window 206. However, in order to assure both the integrity of housing 200 as well as the aesthetic look and feel of housing 200, the reveal formed at the junctions of antenna window 206 with bottom surface 204 and exposed surfaces 208 and 210 of housing 200 must be structurally strong and resilient but also present a sense of both visual and tangible continuity between housing 200 and antenna window 206.

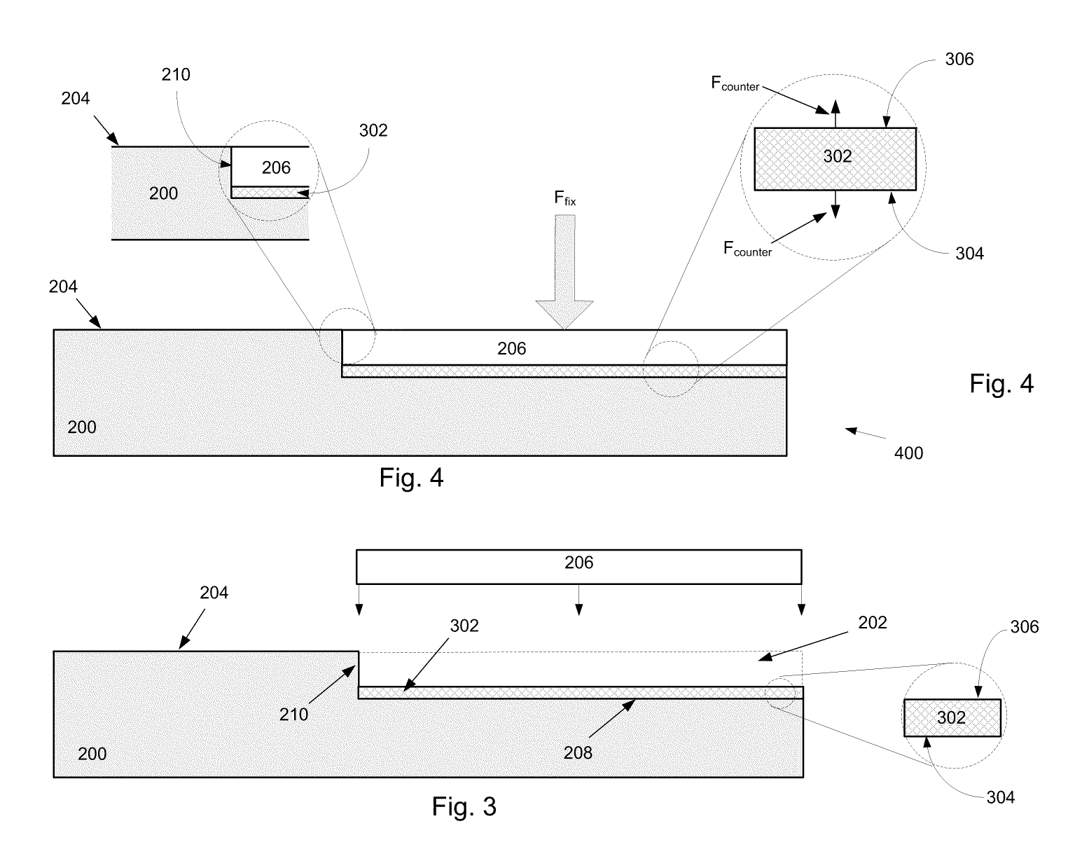

According, FIGS. 3-4 shows a particular approach that can be used to attach antenna window 206 to housing 200 at recess 202 using composite 102 that results in a cosmetically appealing reveal. More particularly, FIG. 3 shows some initial steps that can be taken to attach antenna window 206 to housing 200 using composite portion 302. Firstly, composite portion 302 can be shaped and sized for direct placement upon exposed surface 208. In some cases, portion 302 can have first surface 304 that can be shaped to essentially mirror the contours of exposed surface 208 onto which it will be placed in direct contact. In some embodiments, however, composite portion 302 can be formed into a number of separate pieces each which be placed directly on exposed surface 208 at discrete locations. In any case, it should be noted that there is little or no composite placed on exposed surface 210, thereby assuring a tight and integral fit between antenna window 206 and housing 200. Due to the natural stickiness of composite portion 302, the adhesive force generated by the placement of surface 304 onto exposed surface 208 is sufficient to keep composite portion 302 in place thereby greatly reducing the likelihood of composite portion 302 inadvertently moving and complicating the attachment process. Once composite portion 302 is attached and in place, antenna window 206 can be placed in contact with second surface 306 of composite portion 302 in a manner shown in FIG. 4 to form assembly 400. Again, due to the natural stickiness of composite portion 302, assembly 400 (i.e., housing 200, composite portion 302, and antenna window 206) can remain intact without additional efforts thereby greatly simplifying the attachment process.

Assembly 400 can then be placed within a fixturing device (not shown) that can generate fixturing force F_{fix} applied to assembly 400. It should be noted, however, that unlike using adhesive alone, due to the natural tendency of the foam substrate 104 to return to its original shape and contour, composition portion 302 responds to the application of F_{fix} by generating counterforce F_{count} that can have a magnitude related to a spring force constant of foam substrate 104 and a direction in opposition to F_{fix}. In some cases, F_{count} can be normal to a surface contour of composite portion 302. In this way, F_{count} can be used to accurately and securely control the placement of antenna window 206 on exposed surface 208 in relation to housing 200 and exposed surface 210 within the fixturing device. Once properly secured within the fixturing device, assembly 400 can be exposed to an external environment suitable for curing the liquid adhesive used with foam substrate 104 to form composite portion 302. For example, if the species of liquid adhesive used is thermal cure adhesive, then assembly 400 is exposed to an external temperature of at least the cure temperature for a duration of time suitably long for an appropriate amount of curing to occur. However, again unlike adhesive used alone, any natural contraction of the adhesive due to the curing process within the foam cells can be at least partially offset by the structural integrity of the foam substrate itself. In this way, the dimensional integrity of composite portion 302 can be substantially intact over that possible using adhesive alone. Moreover, in the cured state, composite portion 302 of can become rigid and essentially unyielding resulting in highly stable bond between antenna window 206 and housing 200.

It should be noted that any appropriate adhesive and foam substrate can be used. For example, the adhesive can be a binary adhesive such as two part epoxy, having a base and linker agent. In this embodiment a surface portion of foam substrate can be impregnated with base agent. In another embodiment, however, substantially all of the foam substrate can be impregnated with base agent. Linker agent (material that when combined with base agent results in a cross linking reaction to occur providing a strong bond). In either of the embodiments, the linker agent can be placed on the surfaces to be attached together. In this way, when the coated surfaces are brought in contact with the foam substrate impregnated with the base agent, the cross linking reaction will occur at the surface/foam boundary.

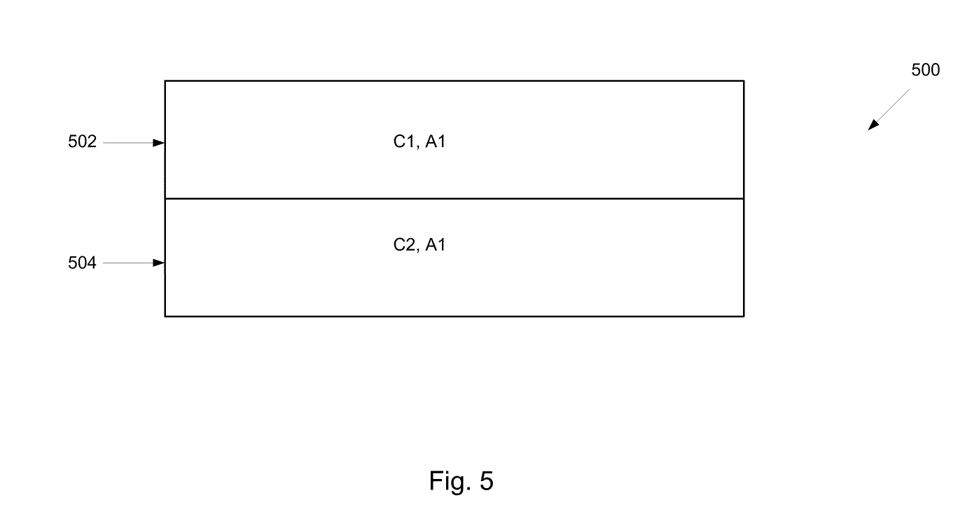

FIG. 5 shows a cross sectional view of composite 500 having a pre-determined non-uniform distribution of adhesive 108 throughout foam substrate 104 in accordance with the described embodiments. In particular, composite 500 can be formed to include region 502 and region 504 each having different physical characteristics based upon differences in the adhesive properties of each region. By adhesive properties it is meant to include at least adhesive species, adhesive concentration and concentration profile, and so on. For example, region 502 can have a concentration C1 of adhesive species A1 whereas region 504 can have a concentration C2, different than C1 of adhesive species A1 or even a totally different adhesive species A2, for example. Therefore, the post cure properties of regions 502 and 504 can be very different from each other. By selecting the appropriate species of adhesive, adhesive concentration and distribution as well as the porosity of foam substrate 104, composite 500 can be customized to exhibit selected properties not possible using a configuration such as composite 102.

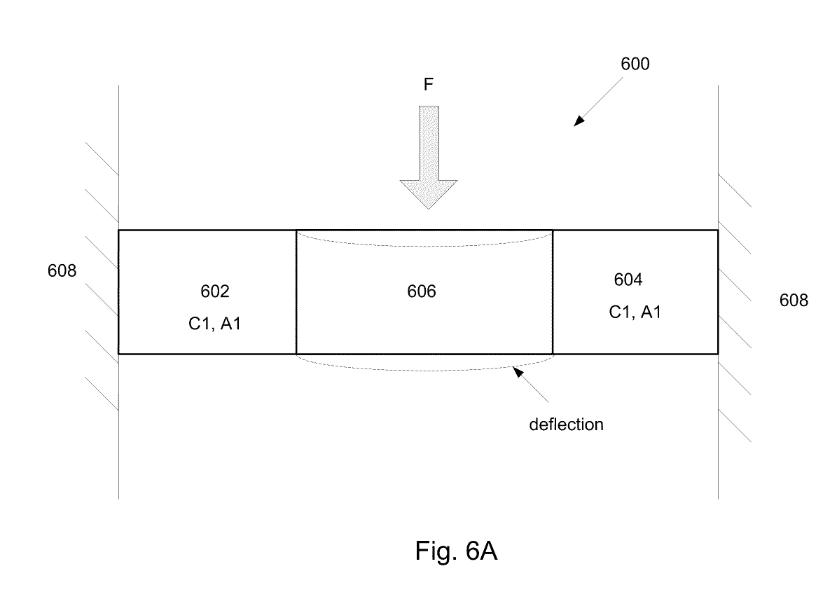

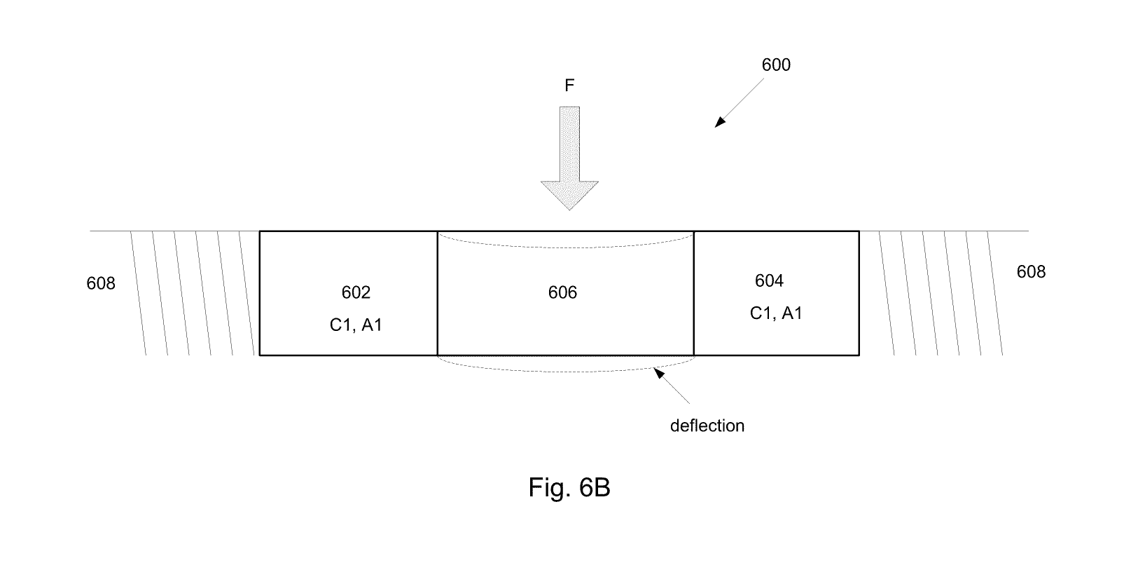

For example, FIGS. 6A-6B shows an embodiment of composite 500 used to form an actuator mechanism 600 in accordance with an embodiment of the invention. In particular, actuator mechanism 600 can be formed of single foam substrate having regions 602 and 604 each having distribution C1 and C2, respectively, of adhesive A1 (or adhesive A2, or even a combination of adhesives A1 and A2). For this example, it is presumed for simplicity only that C1≈C2 but it should be realized that the concentrations can differ (as can the species of adhesive in each region) without loss of generality. Region 606, however, is essentially foam substrate 104 with little or no concentration of adhesive A1 (region 606 can be configured to be impregnated with any liquid adhesive and should not be construed as being limited to little or no adhesive present).

Regions 602 and 604 can be secured to anchoring structure 608 that can, for example, take the form of a housing. Since region 606 does not effectively have any adhesive, the physical properties of region 606 remain substantially unchanged from that of the pre-cure even after actuator mechanism 600 undergoes a cure process. In contrast, however, regions 602 and 604 undergo substantial change from pre to post cure by the curing of adhesive A1. For example, regions 602 and 604 can have properties that change from being flexible and pliant at pre-cure to rigid and firmly attached to anchoring structure 608 at post cure. In this way, by remaining pliant and flexible, region 606 can respond to a applied force F by deflecting distance δ in contrast to regions 602 and 604 that remain rigid and exhibit little or no mechanical deflection caused by force F. In this way, actuator mechanism 600 can respond to force F as would a switch such as a dome button, as an example.

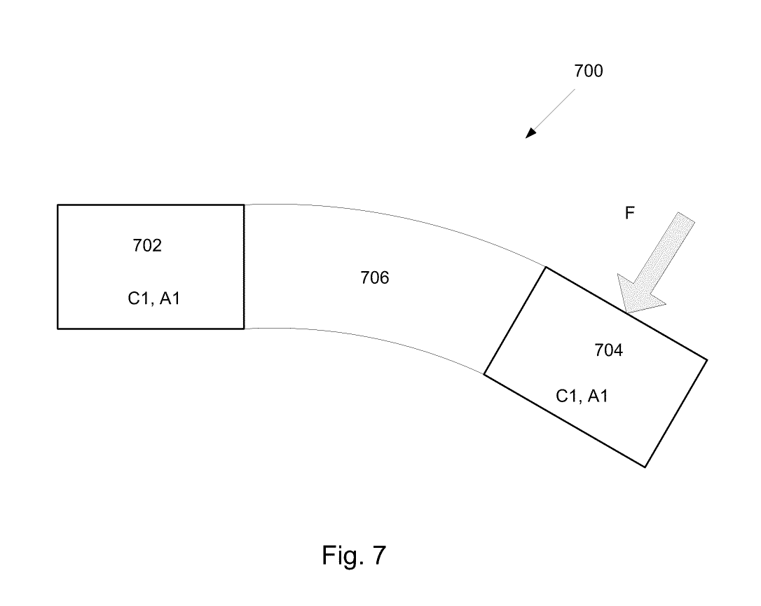

FIG. 7 shows a hinge configuration 700 formed along lines similar to actuator mechanism 600 except that instead of regions 702 and 702 attached to an anchoring structure, regions 702 and 704 are free to move. In this way, regions 702 and 704 can pivot about region 706 along the lines of hinge assembly. For example hinge configuration 700 can be used to provide a form of wrap around support used in, for example, a docking mechanism associated with a portable media player.

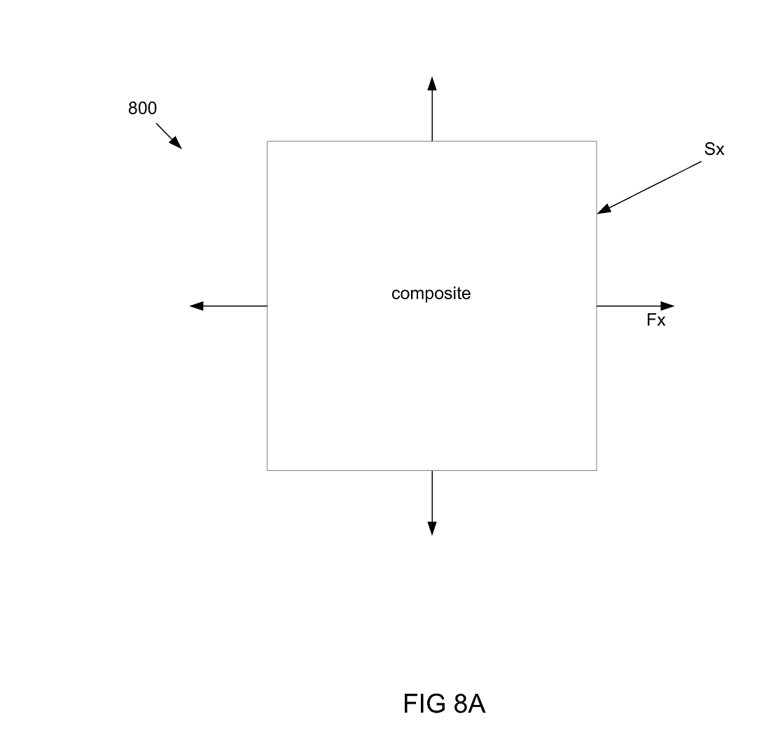

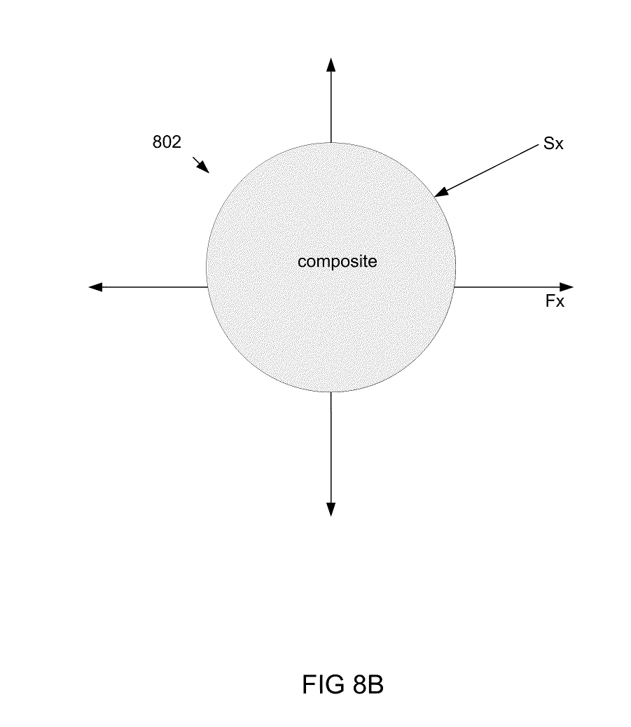

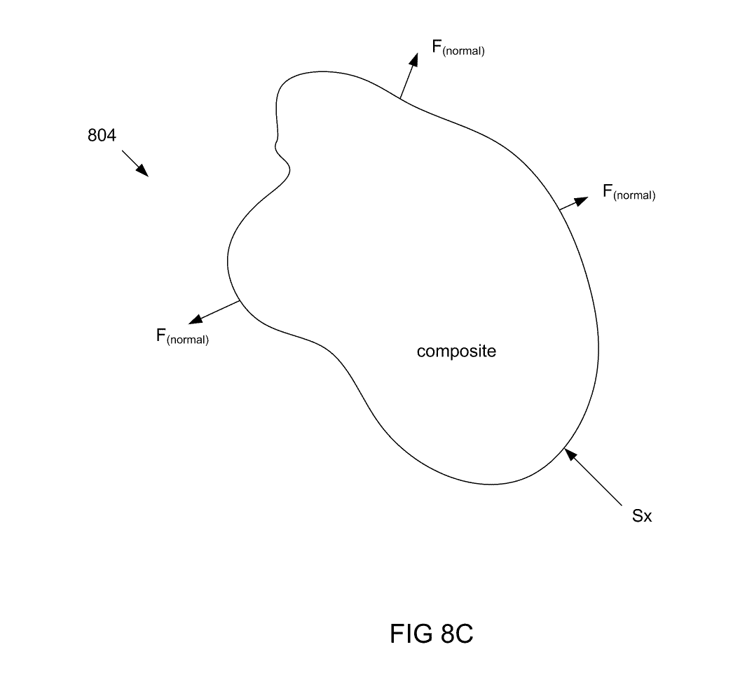

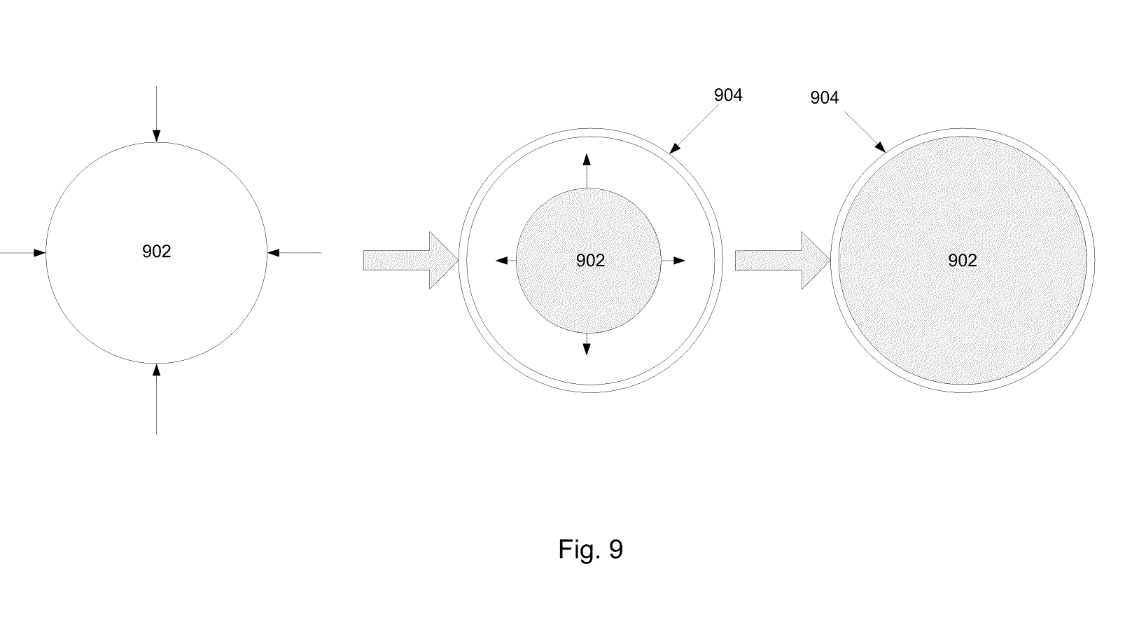

One of the advantages of either form of the composite (with either uniform or non-uniform distributions of adhesive) is the ability to provide well controlled and directional pre-load forces. For example, FIGS. 8A, 8B, and 8C show composite in the form of molded composite 800 having a rectilinear shape (FIG. 8A) a curvilinear shape (FIG. 8B), and general shape (FIG. 8C). When a compressive force Fₓ is applied, uniform preload forces Fₓ can be generated normal to each of the associated surfaces Sₓ. This feature of composite 800 can be used in, for example, assembly processes that require self fixturing and/or self centering such as shown in FIG. 9.

FIG. 9 shows an example of the ability of composite 800 to provide self fixturing that can be used in, for example, a multi-step assembly operation. As discussed above, composite 800 can be formed into any appropriate shape. For example, composite 800 can be initially shaped to match the cross sectional shape of cylinder 902 into which composite 800 is to be placed. Prior to placement within cylinder 902, composite 800 can be formed into the appropriate shape (which in this case happens to be cylindrical) by radially and isotropically applying compression force Fs. In addition to forming composite 800 into the appropriate shape and size, compressive force Fs “activates” composite 800 by engaging the spring force inherent in the foam substrate used to form composite 800. Once composite 800 is compressed and shaped to the appropriate size, shaped composite 800 can be placed within cylinder 902 and allowed to expand to its original shape (or at least as far as cylinder 902 will allow) resulting in counterforce F_{count} being applied radially outward mimicking the original compressive force Fs. In this way, F_{count} can cause composite 800 to automatically centrally align itself within cylinder 902. Once composite 800 has essentially self-centered within cylinder 902, composite 800 can be exposed to a curing environment (such as heat at or above a cure temperature for a thermal adhesive, or UV light of an appropriate wavelength and intensity) for at least a curing time. In this way, the curing of composite 800 can result in a rigid and essentially fully centered assembly formed of assembly 904 formed of cured composite 800/cylinder 902.

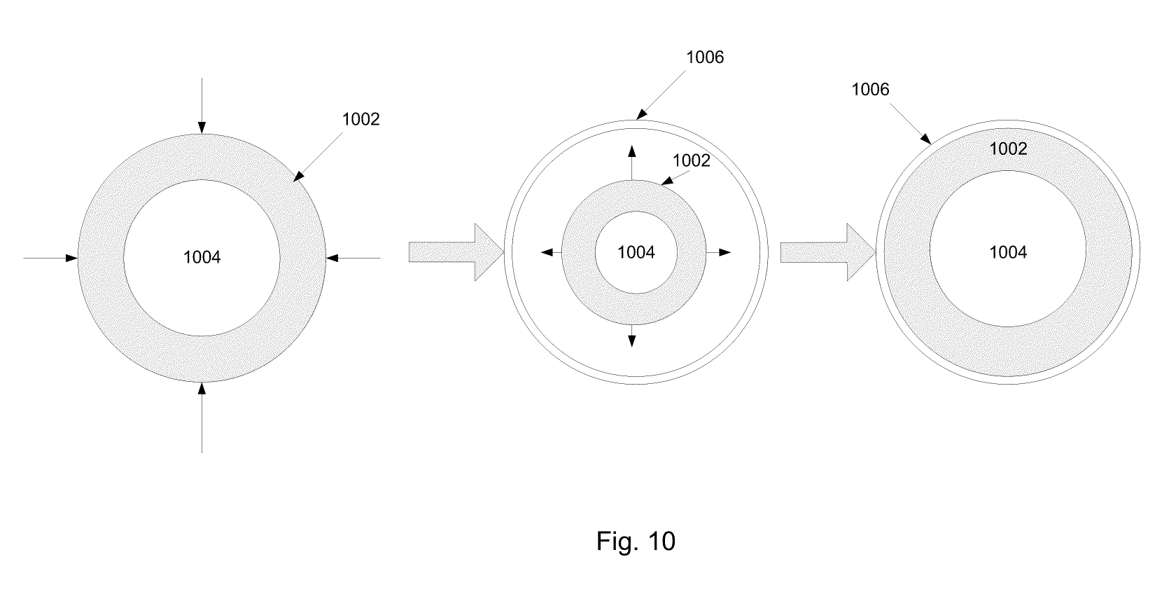

FIG. 10 shows composite 1000 having a non-uniform distribution of adhesive that can be used to, for example, form a shock mount. More specifically, composite 1000 can have a cylindrical shape having an annular region 1002 and a central region 1004. In the described embodiment, annular region 1002 has a concentration of adhesive 1006. In this embodiment, adhesive 1006 can be a binary type adhesive where a linking agent (LA) impregnates a surface portion of annular region 1002 and a corresponding base agent is applied to interior surface 1008 of cylinder 1010. After appropriate compression, composite 1000 is placed within cylinder 1010 followed by a natural expansion of composite 1000 to its original size. However, once annular region 1002 makes contact with interior surface 1008 of cylinder 1010, the base agent and linking agent react forming a mesh of cross links resulting in annular region 1002 becoming firmly attached to cylinder 1010. In this case, when central region 1004 includes little or no adhesive, then central region 1004 retains the compliancy of foam substrate 104 in contrast to the rigidity of annular region 1002. In this way, central region 1004 can be used as, for example, a shock mounts. It should be noted, however, that central region 1004 can be impregnated with UV cure type adhesive. In this way, a UV sensor can be fabricated by judiciously selecting a UV cure adhesive, any exposure to the UV light with the appropriate wavelength can be detected by any indication of curing having had occurred.

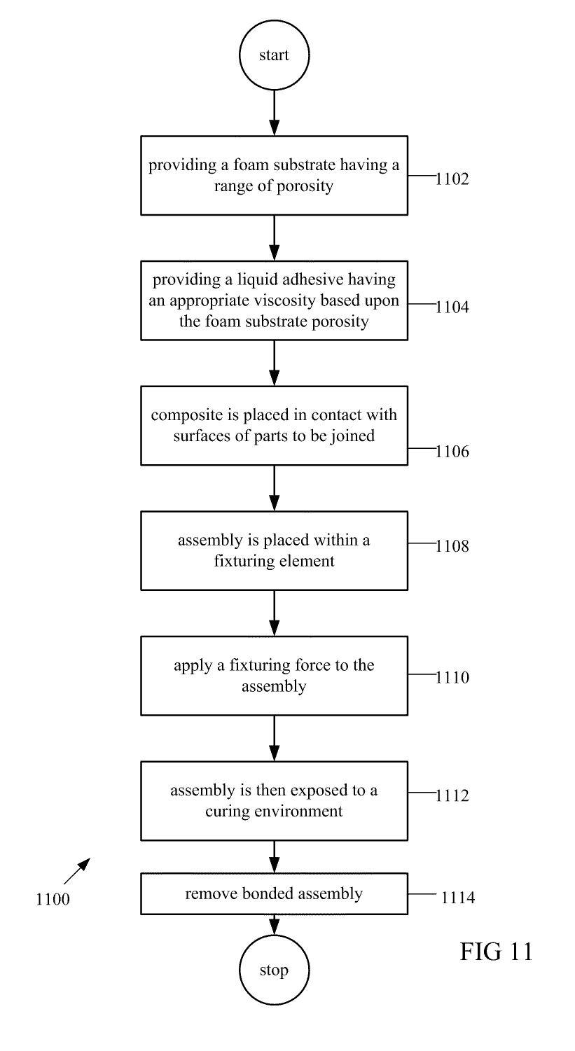

FIG. 11 shows a flowchart detailing a process 1100 for forming a foam/adhesive composite in accordance with the described embodiments. Process 1100 can be carried out by performing at least the following. At 1102, a foam substrate having a range of porosity is provided. In the described embodiment, the porosity of the foam substrate is characteristic of an average number of foam cells per inch having an average cell diameter. At 1104, a liquid adhesive having an appropriate viscosity is provided based upon the foam substrate porosity. The viscosity of the liquid adhesive is such that resistance to flow is sufficiently low to allow at least most of the foam cells to become impregnated with the liquid adhesive to form a substantially uniform distribution of the liquid adhesive. In some embodiments, the liquid adhesive is not permitted to fully impregnate the foam substrate. In this way, a portion of the foam substrate is impregnated with the liquid substrate thereby allowing another species of liquid adhesive, for example, to impregnate at least a part of the remaining portion of the foam substrate. In any case, once the composite is formed, the composite is placed in contact with surfaces of parts to be joined at 1106 (forming in the process a pre-cure structure referred to as an assembly). Thereafter, the assembly can be placed within a fixturing element at 1108 that can be used to apply a fixturing force to the assembly at 1110. The fixturing force can cause the composite to respond by generating a substantially uniform counterforce F_{counter} in a direction normal to and in opposition to the fixturing force allowing much tighter tolerances than would otherwise be possible. The fixture assembly is then exposed to a curing environment (depending upon the adhesive or adhesives used) at 1112 after which the fully bonded assembly can be removed at 1114.

The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A composite material, comprising:
a foam substrate interspersed with a plurality of foam cells having an average foam cell size related to a porosity of the foam substrate; and
a liquid adhesive having a viscosity value, wherein the viscosity value of the liquid adhesive and the foam substrate porosity are interrelated in such a way that an amount of the liquid adhesive migrates into the foam substrate such that most of the plurality of foam cells within at least a first portion of the foam substrate are substantially and uniformly filled with the liquid adhesive.

2. The composite material as recited in claim 1, wherein the first portion extends from a first surface to a second surface of the foam substrate.

3. The composite material as recited in claim 2, wherein the first portion of the composite material bonds at least two parts together by:
placing the first portion of the composite material between the at least two parts to form an assembly,
placing the assembly into a fixturing device,
applying a fixturing force generated by the fixturing device to the assembly,
generating a counter force in opposition to the applied fixturing force by the first portion of the composite material, wherein the counter force stabilizes the assembly,
bonding the assembly together by exposing the assembly to an adhesive curing environment for a duration of time at least equal to an adhesive cure time, and
removing the bonded assembly from the fixturing device.

4. The composite material as recited in claim 2, wherein most of the plurality of foam cells within at least a second portion of the foam substrate are substantially and uniformly filled with at least a second liquid adhesive.

5. The composite material as recited in claim 4, wherein the first and the second portions occupy different regions of the foam substrate.

6. The composite material as recited in claim 5, wherein the first and second adhesives are different adhesives having different conditions for curing.

7. The composite material as recited in claim 6, wherein at least a third portion of the foam substrate contains essentially no adhesive.

8. The composite material as recited in claim 1, wherein when the liquid adhesive is not cured, the composite material retains most of the properties of the foam substrate, wherein when the liquid adhesive is cured, the composite material takes on at least some of the properties of the cured adhesive.

9. The composite material as recited in claim 1, wherein the adhesive is a thermally cured adhesive.

10. The composite material as recited in claim 1, wherein the adhesive is a UV cure adhesive.

11. The composite material as recited in claim 1, wherein the adhesive is a binary adhesive comprising a base agent and a linking agent, wherein the base agent is incorporated into at a surface portion of the composite material and wherein the linking agent is placed upon a surface contacted by the surface portion of the composite, and wherein when the linking agent and the base agent are brought in contact with each other, a cross linking reaction is initiated that results in the formation of a cross linked bond.

12. A small form factor consumer product, comprising:
a housing arranged to enclose a plurality of operational components, the housing having a form factor small enough to be easily carried about by a user with one hand;
a feature, the feature attached to the housing at a reveal; and
an adhesive composite arranged to adhesively attach together the feature such that the reveal is not visible to the user and is not tangible to the user, wherein the adhesive composite comprises:
a foam substrate having a number of foam cells, and
a substantially uniform distribution of liquid adhesive amongst the number of foam cells.

13. The small form factor consumer product as recited in claim 12, wherein the housing and the feature are attached together by:
forming an assembly by placing the adhesive composite between facing surfaces of the housing and the feature to form an assembly,
placing the assembly into a fixturing device arranged to generate a fixturing force used to compress the adhesive composite between the facing surfaces of the housing and the feature,
applying the fixturing force to the assembly,
curing the adhesive; and
removing the attached first and second parts from the fixturing device.

14. The small form factor consumer product as recited in claim 13, wherein the small form factor computer product is a portable media player.

15. A method, comprising:
providing a foam substrate having a range of porosity values;
determining a viscosity of a first liquid adhesive, the viscosity of the liquid adhesive in accordance with a substantially uniform distribution of the liquid adhesive in at least a portion of the foam substrate; and
forming a foam/adhesive composite material by causing the liquid adhesive to impregnate at least the portion of the foam substrate.

16. The method as recited in claim 15, further comprising:
providing a second liquid adhesive different from the first liquid adhesive; and
causing the second liquid adhesive to impregnate at least another portion of the foam substrate.

17. The method as recited in claim 16, wherein the foam substrate is exposed to a first cure environment suitable for curing only the first liquid adhesive.

18. The method as recited in claim 17, wherein the foam substrate is subsequently exposed to a second cure environment suitable for curing the second liquid adhesive.

19. A method, comprising:
providing a foam substrate having a range of porosity values;
determining a viscosity of a first liquid adhesive, the viscosity of the liquid adhesive in accordance with a substantially uniform distribution of the liquid adhesive in at least a portion of the foam substrate; and
forming a foam/adhesive composite material by causing the liquid adhesive to impregnate at least the portion of the foam substrate.

20. The method as recited in claim 19, further comprising:
providing a second liquid adhesive different from the first liquid adhesive; and
causing the second liquid adhesive to impregnate at least another portion of the foam substrate.

21. The method as recited in claim 20, wherein the foam substrate is exposed to a first cure environment suitable for curing only the first liquid adhesive.

22. The method as recited in claim 21, wherein the foam substrate is subsequently exposed to a second cure environment suitable for curing the second liquid adhesive.
